(19) United States
(12) Patent Application Publication
(10) Pub. No.: US 2025/0163903 A1
(43) Pub. Date: May 22, 2025

(54) CONDENSATE BURNOFF

(71) Applicant: HITACHI GLOBAL AIR POWER US, LLC, Michigan City, IN (US)

(72) Inventors: Daniel QUALKENBUSH, Michigan City, IN (US); Andrew SWART, Michigan City, IN (US); Chris SHOLTIS, Michigan City, IN (US)

(21) Appl. No.: 18/841,296

(22) PCT Filed: Sep. 30, 2022
(86) PCT No.: PCT/US2022/045461

§ 371 Date: Aug. 23, 2024

(51) Int. Cl. F04B 39/16; B01D 53/26; F04B 39/06

(52) U.S. Cl. CPC F04B 39/16; B01D 53/265; F04B 39/06

(57) ABSTRACT

A condensate treatment system includes a separator that separates a condensate from an air stream exited from a compressor, a heat exchanger that heats the separated condensate, an evaporative heater that evaporates the heated condensate exited from the heat exchanger, and a vent tube through which the evaporated heated condensate mixes with a cooling air stream that is exited from the compressor.

### BACKGROUND

### Field

The present disclosure is generally related to portable air compressors, and more specifically, to a condensate treatment system integrated in portable air compressors.

### Related Art

In the related art, there are collection systems that collect condensate in stationary compressor systems.

However, conventional condensate collection systems have not been used in portable compressors. This results in a constant cost on the customer to collect and process the condensate.

Thus, there is an unmet need for a condensate management system on portable compressors using the exhaust stream.

The present invention is directed to a compact compressor and condensate treatment system mounted within the compressor package that takes up less floor space and making the proposed integrated system more portable than conventional systems.

### SUMMARY

The subject invention is a condensate treatment and removal system for compressors, and for particularly portable compression devices.

The condensate would be separated from an air stream through a moisture separator. Then the separated condensate would be directed to a heat transfer device (e.g., shell and tube, bar and plate, etc.). Once through the heat transfer device, the condensate is sprayed at electric heating elements inside an evaporative heater. Lastly, the evaporated condensate is released into an air stream of a cooling fan of the compressor.

Aspects of the present disclosure involve a condensate treatment system that includes a separator that separates a condensate from an air stream exited from a compressor, a heat exchanger that heats the separated condensate, an evaporative heater that evaporates the heated condensate exited from the heat exchanger, and a vent tube through which the evaporated heated condensate mixes with a cooling air stream exited from the compressor.

Aspects of the present disclosure further involve a combined compression and condensate treatment system, including a compressor that compresses an air stream, and a condensate treatment system integrated with the compressor within the combined compression and condensate treatment system. The condensate treatment system includes a separator that separates a condensate from the air stream exited from the compressor, a heat exchanger that heats the separated condensate, an evaporative heater that evaporates the heated condensate exited from the heat exchanger, and a vent tube through which the evaporated heated condensate mixes with a cooling air exited from the compressor.

Aspects of the present disclosure further involve a method for treatment of a condensate of a compressor, including separating, in a condensate treatment system, the condensate from an air stream exited from the compressor, heating the separated condensate in a heat exchanger, evaporating the heated condensate exited from the heat exchanger, and mixing, in a vent tube, the evaporated condensate with a cooling air exited from the compressor. The compressor is attached to the condensate treatment system such that an entirety of the condensate treatment system and the compressor is a unitary piece.

Aspects of the present disclosure further involve a condensate treatment system that includes separating means that separates a condensate from an air stream exited from compression means, heat exchange means that heats the separated condensate, evaporative heating means that evaporates the heated condensate exited from the heat exchange means, and venting means through which the evaporated heated condensate mixes with a cooling air exited from the compression means.

With the exemplary aspects of the present disclosure, a combined and integrated condensate collection system and compression can be provided such that a customer would no longer need an external collection system of condensate. Further, challenges with disposal of the collected condensate in conventional compressors can be resolved.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example condensate collection system for an air compressor, in accordance with an example implementation.

FIG. 2 illustrates an example view of a condensate collection system integrated in an air compressor, in accordance with an example implementation.

FIG. 3 illustrates an example view of an evaporative heater of an example condensate collection system, in accordance with an example implementation.

FIG. 4 illustrates an example of a condensate collection system, in accordance with an example implementation.

FIG. 5 illustrates exemplary fluid transfer paths in an example condensate collection system, in accordance with an example implementation.

FIG. 6 illustrates an example of a condensate collection method, in accordance with an example implementation.

FIG. 7 illustrates an example view of a control system for an evaporative heater of an example condensate collection system, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

Example implementations described herein involve a portable compressor package that can provide a solution to manage condensate created by the compression of humid air.

After cooling compressed air, moisture ingested with the air is condensed resulting in a saturated compressed air/water mixture. This mixture is routed through a water separator and coalescing filters where the condensate is separated from the compressed air.

This condensate is then routed to a heat exchanger. Waste heat of compression from the compressor oil is utilized to heat the condensate to a higher temperature prior to injection into an evaporative heater module. Use of waste heat in this manner reduces the power requirements of the evaporative heaters and increases overall efficiency of the system. Different types of heat exchangers (e.g., using shell and tube, brazed plate, etc.) could be used to accomplish pre-heating of the condensate.

Additionally, heat contained within the evaporative heater module could be used to pre-heat the condensate by routing the condensate through the device via heat conductive tubing.

From the heat exchanger, the condensate is routed to the evaporative heater module. As the condensate is under pressure, an orifice or a nozzle is used to atomize the condensate and spray it directly onto electrically powered heating elements. The heat within the evaporative heater and surface temperatures of the elements evaporates the condensate.

The quantity and size of heating elements can be modified to match the amount of condensate coming into the module. The evaporator heater can be thermally insulated to improve heat retention and performance in a cold weather. It also envisioned to utilize a heated plate for evaporation in place of individual elements.

The evaporated condensate then exits the evaporator heater via a vent. Vent placement is intentionally situated into the cooling air stream so that the evaporated condensate is mixed with warm cooling air and carried out of the machine before it has an opportunity to condense back into water.

The evaporator module, heat exchanger, vent tube and associated piping, and electrical connections are all seamlessly integrated into the compressor package offering a complete solution. Controls are integrated to power the heaters when the compressor is running and producing compressed air.

Fault protection can be provided to detect when condensate level is high within the evaporator module or when a heater element has failed. Additionally, bypass piping is provided to allow condensate to be routed to a collection vessel in the event of a failure.

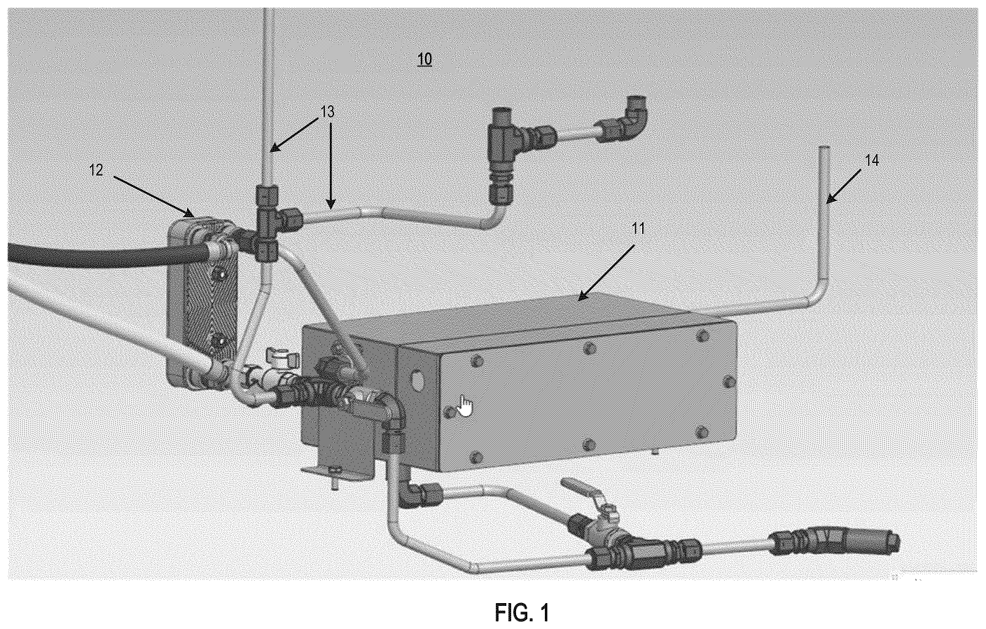

FIG. 1 illustrates an example configuration of a condensate collection system 10 for an air compressor, in accordance with an example implementation.

Exemplary components of the condensate collection system 10 can include, but not limited to separators connected to separator pipes 13, a heat exchanger 12, an evaporative heater 11, and a vent tube 14.

The saturated compressed air/water mixture, which resulted in cooling compressed air, passes through a water separator and coalescing filters where the condensate is separated from the compressed air and is collected in separator pipes 13.

This condensate is then routed through the separator pipes 13 to the heat exchanger 12.

In the heat exchanger 12, waste heat of compression from the compressor oil can be applied to heat the condensate to a higher temperature prior to injection into the evaporative heater 11.

Further, in the heat exchanger 12, the heat contained within the evaporative heater 11 could be used to pre-heat the condensate.

From the heat exchanger 12, the condensate is routed to the evaporative heater 11. The heat within the evaporative heater 11 and surface temperatures of the elements of the evaporative heater 11 evaporates the condensate.

The quantity and size of heating elements can be modified to match the amount of condensate coming into the evaporative heater 11.

The evaporated condensate then exits the evaporative heater 11 via a vent tube 14. The vent tube 14 provides the evaporated condensate for mixing with warm cooling air exited from a compressor before it has an opportunity to condense back into water.

The evaporative heater 11, heat exchanger 12, vent tube 14, separator pipes 13, associated piping, and electrical connections are all seamlessly integrated into the compressor package to have a compact compressor and condensate treatment system.

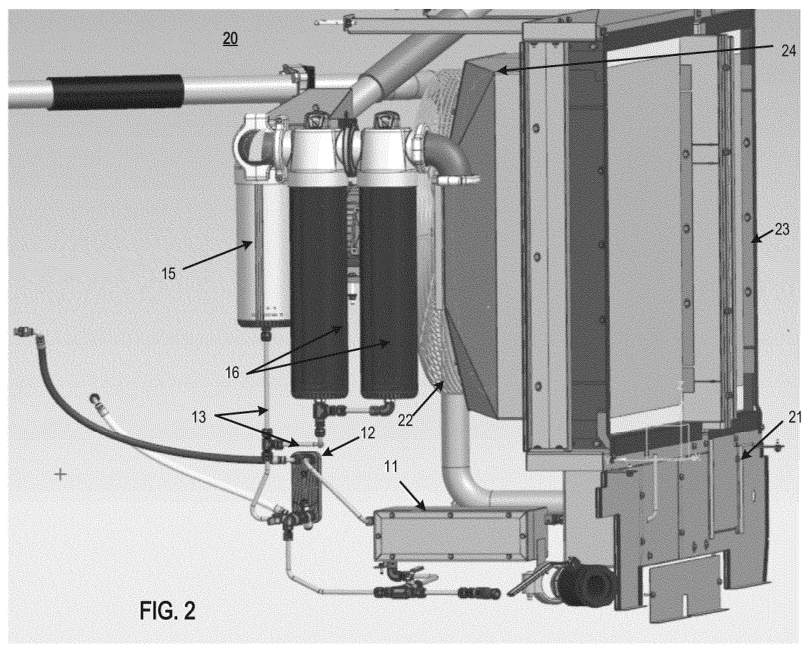

FIG. 2 illustrates an example view of a combined condensate collection system integrated in an air compressor 20, in accordance with an example implementation.

As shown in the exemplary FIG. 2, the components of the condensate collection system 10 shown in FIG. 1 and described above, is attached to compressor 24 to provide a compact condensate treatment system integrated with compressor 24.

The evaporated condensate that exits the evaporative heater 11 is transferred to conduct pipes 21 of compressor 24 to be introduced to the exit ducts 23 of the compressor 24 for mixing with a cooling air stream that has passed through fan 22 of the compressor 24.

The vent placement is intentionally situated into the cooling air stream through conduct pipes 21 and exit ducts 23 so that the evaporated condensate is mixed with cooling air that has passed through fan 22, and is carried out of the combined condensate collection system and air compressor 20 before the condensate has an opportunity to condense back into water.

FIG. 2 also shows the components of the separator, connected to the separator pipes 13, which include filters 16 and water separator 15.

Filters 16 and water separator 15, as a collective separator, separate the condensate from the compressed air of compressor 24 for heating in the heat exchanger 12, evaporating in the evaporative heater 11, feeding into the conduct pipes 21, and mixing with cooling air stream in the exit ducts 23.

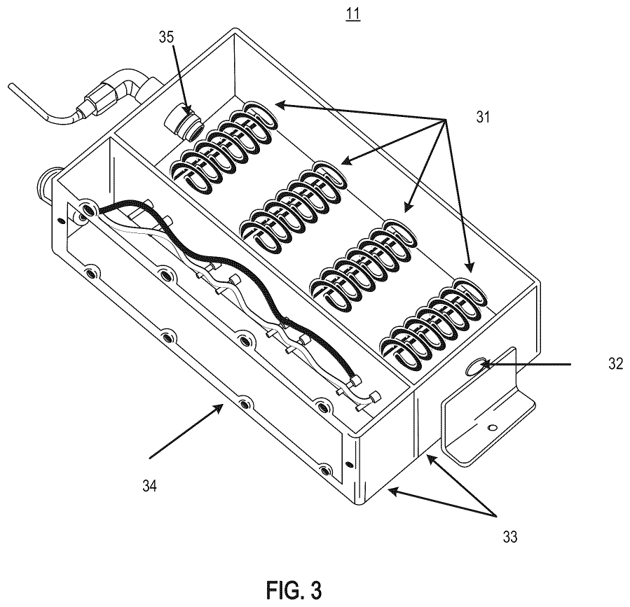

FIG. 3 illustrates an example view of an evaporative heater 11 of an example condensate collection system, in accordance with an example implementation.

The evaporative heater 11 may be incorporated, for example, into a stainless steel welded box and hardware 33.

As the condensate is under pressure in the evaporative heater 11, an orifice or a nozzle 35 is used to atomize the condensate and spray it directly onto electrically powered heating elements 31. The heat within the evaporative heater 11 and surface temperatures of the heating elements 31 evaporates the condensate.

The quantity and size of heating elements 31 can be modified to match the amount of condensate that enters into the evaporative heater 11, and after evaporation, is exited through vent 32.

The evaporative heater 11 can be thermally insulated, for example, with a gasket cover 34, to improve heat retention and performance in a cold weather.

Exemplary aspects may include a heated plate for evaporation in place of individual heating elements 31.

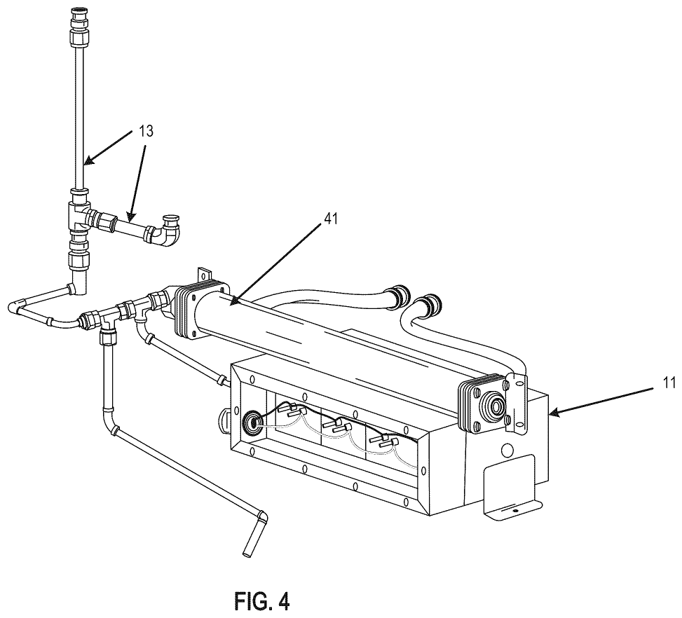

FIG. 4 illustrates an example of a condensate collection system, in accordance with an example implementation.

In the exemplary condensate collection system of FIG. 4, a shell and tube heat exchange 41 preheats the condensate that enters the heat exchange 41 from separator pipes 13 and transfers the preheated condensate to the evaporative heater 11.

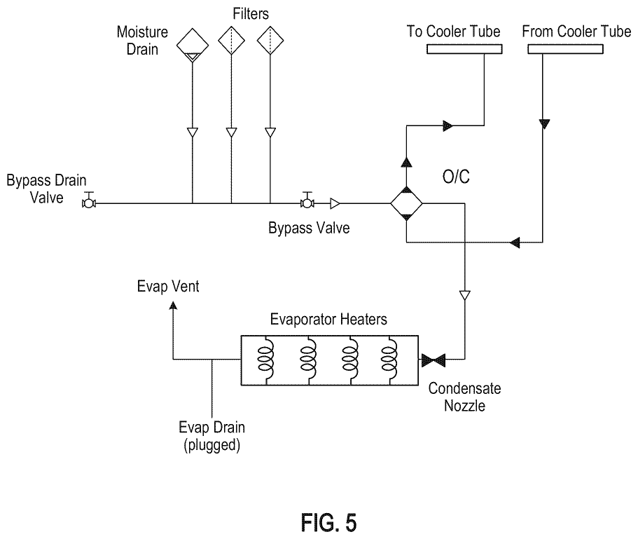

FIG. 5 illustrates exemplary fluid transfer paths in an example condensate collection system, in accordance with an example implementation.

As previously described, the condensate path includes exit liquid of filters and moisture drain toward the heat exchanger O/C before entering condensate nozzle in evaporator heaters, which evaporate the condensate for exit toward evaporation vent.

Bypass valve, bypass drain valve, and evaporation drain are provided in the condensate path to allow condensate to be routed to a collection vessel in case of a failure in the condensate treatment system.

A heat transfer medium is provided to heat exchange O/C through a cooler tube to provide preheating to the condensate before entering the condensate nozzle.

Based on the condensate treatment system described above as shown in the exemplary FIGS. 1-5, an exemplary aspect of the present disclosure is directed to a condensate treatment system 10 that includes a separator 15/16 that separates a condensate from an air stream exited from a compressor 24, a heat exchanger 12 that heats the separated condensate, an evaporative heater 11 that evaporates the heated condensate exited from the heat exchanger 12, and a vent tube 14 through which the evaporated heated condensate mixes with a cooling air exited from the compressor 24.

The condensate is within a compressed humid air in the air stream from cooling fan 22.

The separator includes a water separator 15 and a plurality of filters 16. The heat exchanger 12 applies heat of compression from a compressor oil of the compressor 24 to heat the condensate.

In an exemplary embodiment, the heat exchanger 12 includes a shell and tube heater. In another exemplary embodiment, the heat exchanger 12 includes a brazed plate.

The evaporative heater 11 includes an orifice or a nozzle 35 that atomizes the heated condensate to spray the heated condensate on heating elements 31. The heat contained within the evaporative heater 11 preheats the heated condensate.

The condensate treatment system 10 is integrated with the compressor 24 in a portable compression and condensate treatment system 20.

The condensate treatment system 10 is attached to the compressor 24 such that an entirety of the condensate treatment system and the compressor is a unitary piece.

An entirety of the condensate treatment system 10 and the compressor 24 is a single portable unitary piece.

Another exemplary aspect of the present disclosure is directed to a combined compression and condensate treatment system 20, including a compressor 24 that compresses an air stream, and a condensate treatment system 10 integrated with the compressor 24 within the combined compression and condensate treatment system 20.

The condensate treatment system 10 includes a separator 15/16 that separates a condensate from an air stream exited from a compressor 24, a heat exchanger 12 that heats the separated condensate, an evaporative heater 11 that evaporates the heated condensate exited from the heat exchanger 12, and a vent tube 14 through which the evaporated heated condensate mixes with a cooling air exited from the compressor 24.

The condensate treatment system 10 is attached to the compressor 24 such that an entirety of the condensate treatment system 10 and the compressor 24 is a unitary piece.

An entirety of the condensate treatment system 10 and the compressor 24 is a single portable unitary piece.

Another exemplary aspect of the present disclosure is directed to a condensate treatment system 10 that includes separating means 15/16 that separates a condensate from an air stream exited from compression means 24, heat exchange means 12 that heats the separated condensate, evaporative heating means 11 that evaporates the heated condensate exited from the heat exchange means 12, and venting means 14 through which the evaporated heated condensate mixes with a cooling air exited from the compression means 24.

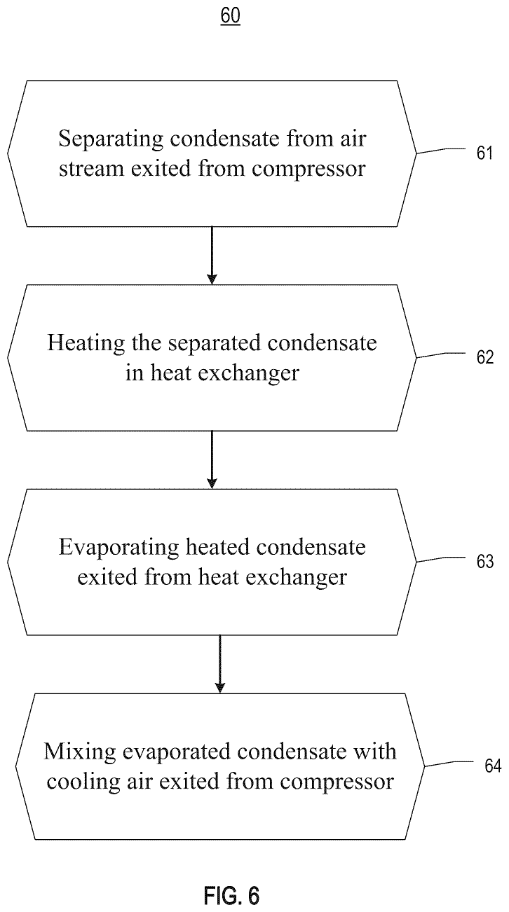

Another exemplary aspect of the present disclosure, as shown for example in FIG. 6, is directed to a method 60 for treatment of a condensate of a compressor 24.

The method 60 includes, in step 61, separating, in a condensate treatment system 10, the condensate from an air stream exited from the compressor 24, heating, in step 62, the separated condensate in a heat exchanger 12, evaporating, in step 63, the heated condensate exited from the heat exchanger 12, and, in step 64, mixing, in a vent tube 14, the evaporated condensate with a cooling air exited from the compressor 24,

The compressor 24 is attached to the condensate treatment system 10 such that an entirety of the condensate treatment system 10 and the compressor 24 is a unitary piece.

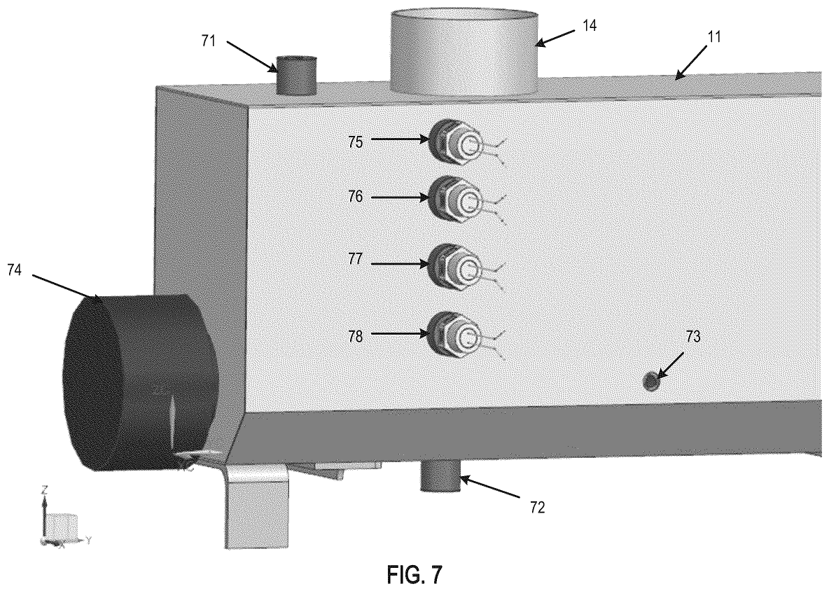

Another exemplary aspect of the present disclosure is shown in FIG. 7 that illustrates an example view of a control system for an evaporative heater 11 of an example condensate collection system, in accordance with an example implementation.

The evaporative heater 11 is connected to entrance condensate pipe 71, the vent pipe 14, and the drain exit pipe 72.

In the exemplary evaporative heater 11 of FIG. 7, a single heating element 74 performs the evaporation heating, which may result in a better serviceability and simplicity in design compared to the multiple heating elements in the evaporative heater 11.

The control scheme for the operation of the evaporative heater 11 includes a temperature probe 73 that controls the temperature of the heating element 74, a condensate level limit switch 75 that controls a level of the condensate inside the evaporative heater 11, a heating element turn on switch 76, a heating element testing switch 77 for testing and calibration of the heating element 74, and a heating element turn off switch 78 that collective control the evaporative heater 11.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

The foregoing detailed description has set forth various example implementations of the devices and/or processes via the use of diagrams, schematics, and examples. Insofar as such diagrams, schematics, and examples contain one or more functions and/or operations, each function and/or operation within such diagrams, or examples can be implemented, individually and/or collectively, by a wide range of structures. While certain example implementations have been described, these implementations have been presented by way of example only and are not intended to limit the scope of the protection. Indeed, the novel methods and apparatuses described herein may be embodied in a variety of other forms. Furthermore, various omissions, substitutions and changes in the form of the devices and systems described herein may be made without departing from the spirit of the protection. The accompanying claims and their equivalents are intended to cover such forms or modifications as would fall within the scope and spirit of the protection.

What is claimed is:

1. A condensate treatment system, comprising
a separator that separates a condensate from an air stream exited from a compressor;
a heat exchanger that heats the separated condensate;
an evaporative heater that evaporates the heated condensate exited from the heat exchanger; and
a vent tube through which the heated condensate that is evaporated mixes with a cooling air stream that is exited from the compressor.

2. The condensate treatment system according to claim 1, wherein the condensate is within a compressed humid air in the air stream.

3. The condensate treatment system according to claim 1, wherein the separator includes a water separator and a plurality of filters.

4. The condensate treatment system according to claim 1, wherein the heat exchanger applies heat of compression from a compressor oil of the compressor to heat the condensate.

5. The condensate treatment system according to claim 1, wherein the heat exchanger includes a shell and tube heater.

6. The condensate treatment system according to claim 1, wherein the heat exchanger includes a brazed plate.

7. The condensate treatment system according to claim 1, wherein the evaporative heater includes an orifice or a nozzle that atomizes the heated condensate to spray the heated condensate on a plurality of heating elements.

8. The condensate treatment system according to claim 1, wherein heat contained within the evaporative heater preheats the heated condensate.

9. The condensate treatment system according to claim 1, wherein the condensate treatment system is integrated with the compressor in a portable compression and condensate treatment system.

10. The condensate treatment system according to claim 1, wherein the condensate treatment system is attached to the compressor such that an entirety of the condensate treatment system and the compressor is a unitary piece.

11. The condensate treatment system according to claim 1, wherein an entirety of the condensate treatment system and the compressor is a single portable unitary piece.

12. The condensate treatment system according to claim 1, wherein the evaporative heater includes a single heating element, the evaporative heater comprising one of an orifice and a nozzle that atomizes the heated condensate to spray the heated condensate on the single heating element.

13. The condensate treatment system according to claim 12, wherein the evaporative heater further includes:
a temperature probe that controls a temperature of the single heating element; and
a plurality of switches that control an operation of the single heating element in the evaporative heater.

14. The condensate treatment system according to claim 13, wherein the plurality of switches include:
a condensate level limit control switch;
a heating element turn on switch; and
a heating element turn off switch.

15. A combined compression and condensate treatment system, comprising
a compressor that compresses an air stream; and
a condensate treatment system integrated with the compressor within the combined compression and condensate treatment system,
wherein the condensate treatment system comprises:
a separator that separates a condensate from the air stream exited from the compressor;
an evaporative heater that evaporates the condensate; and
a vent tube through which the heated condensate that is evaporated mixes with a cooling air stream that is exited from the compressor.

16. The combined compression and condensate treatment system according to claim 15, further comprising:
a heat exchanger that heats the separated condensate before entering the evaporative heater.

17. The combined compression and condensate treatment system according to claim 15, wherein the condensate treatment system is attached to the compressor such that an entirety of the condensate treatment system and the compressor is a unitary piece.

18. The combined compression and condensate treatment system according to claim 15, wherein an entirety of the condensate treatment system and the compressor is a single portable unitary piece.

19. A method for treatment of a condensate of a compressor, the method comprising separating, in a condensate treatment system, the condensate from an air stream exited from the compressor;
heating the separated condensate in a heat exchanger;
evaporating the heated condensate exited from the heat exchanger; and
mixing, through a vent tube, the heated condensate that is evaporated with a cooling air stream that is exited from the compressor,
wherein the compressor is attached to the condensate treatment system such that an entirety of the condensate treatment system and the compressor is a unitary piece.
